(19) United States
(12) Patent Application Publication
(10) Pub. No.: US 2023/0413778 A1
(43) Pub. Date: Dec. 28, 2023

(54) MODULAR ANIMAL SHELTERS

(71) Applicant: CATSA Ltd., Pittsburgh, PA (US)

(72) Inventors: Samantha Ginsburg, Pittsburgh, PA (US); Stephen Streibig, Pittsburgh, PA (US)

(21) Appl. No.: 18/367,426

(22) Filed: Sep. 12, 2023

Related U.S. Application Data
(63) Continuation of application No. 29/853,023, filed on Sep. 12, 2022.
Application No. 29/853,023 is a continuation-in-part of application No. 29/727,334, filed on Mar. 10, 2020, now Pat. No. D966624.
(60) Provisional application No. 63/405,797, filed on Sep. 12, 2022.

(51) Int. Cl. A01K 1/03

(52) U.S. Cl. CPC A01K 1/033

(57) ABSTRACT

A modular animal shelter is disclosed including top and bottom modules that may be of identical shape and which form an interior enclosure for animals such as cats when assembled together. The top module includes a top module roof, a first top module sidewall having a first lower edge, and a second top module sidewall having a second lower edge. The bottom module includes a bottom module floor, a first bottom module sidewall having a first upper edge, and a second bottom module sidewall having a second upper edge. The first lower edge of the first top module sidewall engages the first upper edge of the first bottom module sidewall, and the second lower edge of the second top module sidewall engages the second upper edge of the second bottom module sidewall to thereby form the enclosure. The modular animal shelter may also include a first endwall installed at a first end of the modular animal shelter including a peripheral edge adjacent the top module and the bottom module that at least partially encloses the first end of the modular animal shelter, and may further include a second endwall installed at a second end of the modular animal shelter opposite the first end including a peripheral edge adjacent the top module and the bottom module that at least partially encloses the second end of the modular animal shelter. The first and second endwalls may be of identical shape. Door openings may be provided in the first endwall and/or second endwall to allow animals to enter and exit the modular animal shelter.

### CROSS-REFERENCE TO RELATED APPLICATIONS

This application claims the benefit of U.S. Provisional Patent Application No. 63/405,797 filed Sep. 12, 2022, and also claims the benefit of U.S. Design Application No. 29/853,023 filed Sep. 12, 2022, which is a continuation-in-part of U.S. Design Application No. 29/727,334 filed Mar. 10, 2020, now U.S. Design Pat. No. D966,624, all of which are incorporated herein by reference.

### FIELD OF THE INVENTION

The present invention relates to modular animal shelters.

### BACKGROUND INFORMATION

The use of animal shelters to protect animals from natural elements is an important feature of animal care. These animal shelters often include large open interior spaces. Shipping costs increase with any increase in size of the shipped item, thus making empty space costly for shipping. Costs of manufacturing animal shelters also increases with increased complexity of the design. There is also a desire of customizability of animal shelters by users to personalize the animal shelters. Therefore, there is a need to provide shelter to animals from natural elements while decreasing shipping and manufacturing costs while still providing customizability of the orientation of the shelter.

### SUMMARY OF THE INVENTION

An aspect of the present invention is to provide a modular animal shelter including top and bottom modules that may be of identical shape and which form an interior enclosure for animals such as cats when assembled together. The top module includes a top module roof, a first top module sidewall having a first lower edge, and a second top module sidewall having a second lower edge. The bottom module includes a bottom module floor, a first bottom module sidewall having a first upper edge, and a second bottom module sidewall having a second upper edge. The first lower edge of the first top module sidewall engages the first upper edge of the first bottom module sidewall, and the second lower edge of the second top module sidewall engages the second upper edge of the second bottom module sidewall to thereby form the enclosure. The modular animal shelter may also include a first endwall installed at a first end of the modular animal shelter including a peripheral edge adjacent the top module and the bottom module that at least partially encloses the first end of the modular animal shelter, and may further include a second endwall installed at a second end of the modular animal shelter opposite the first end including a peripheral edge adjacent the top module and the bottom module that at least partially encloses the second end of the modular animal shelter. The first and second endwalls may be of identical shape. Door openings may be provided in the first endwall and/or second endwall to allow animals to enter and exit the modular animal shelter.

These and other aspects of the present invention will be more apparent from the following description.

### BRIEF DESCRIPTION OF THE DRAWINGS

FIGS. 1-8 are top isometric, bottom isometric, front, rear, first side, second side, top and bottom views of a modular animal shelter in accordance with an embodiment of the present invention.

FIGS. 9-14 are exploded isometric, bottom isometric, front, rear, first side and second side of the modular animal shelter of FIGS. 1-8.

FIGS. 15-22 are top isometric, bottom isometric, front, rear, first side, second side, top and bottom views of the modular animal shelter of FIGS. 1-8 with a removable cover in accordance with an embodiment of the present invention.

### DETAILED DESCRIPTION

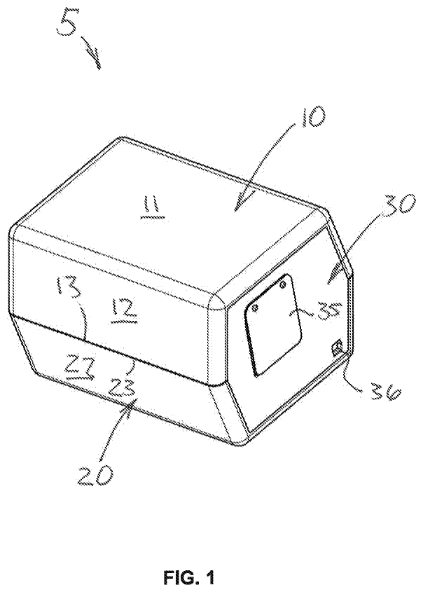

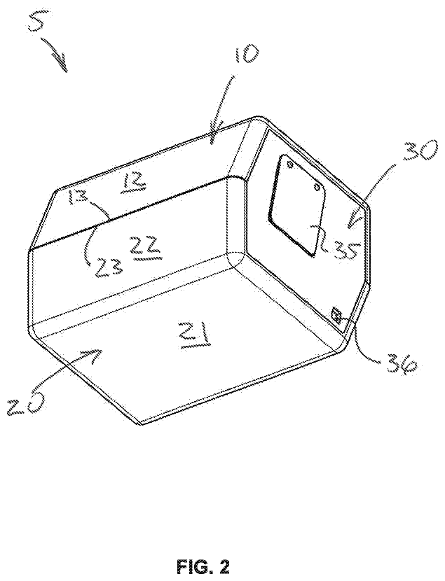

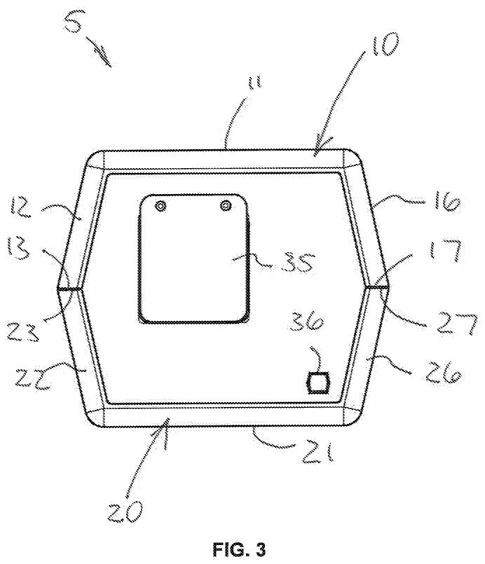

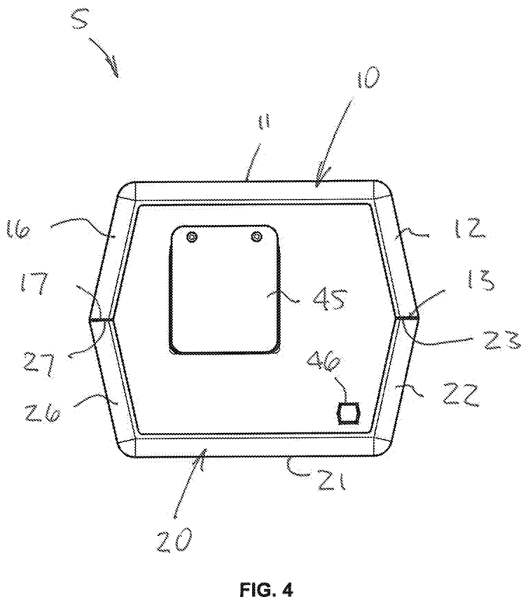

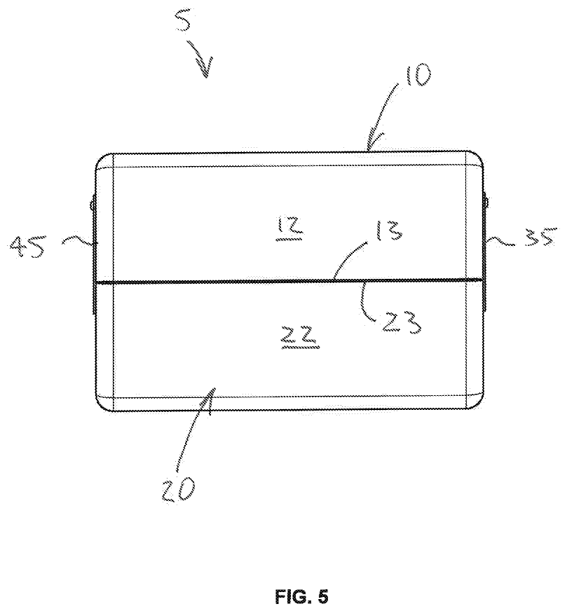

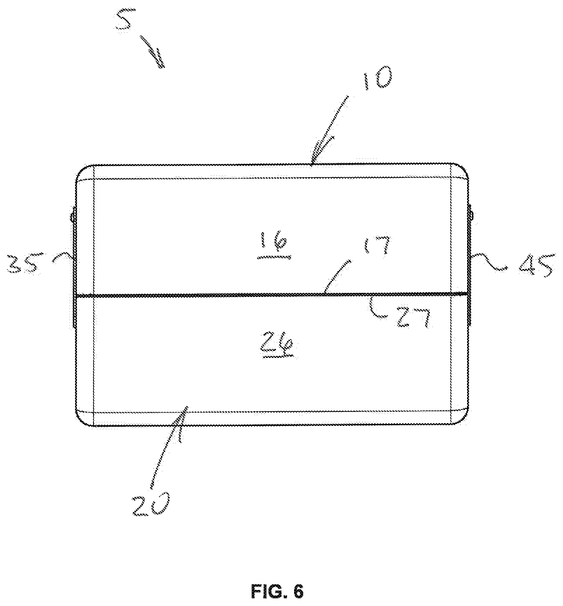

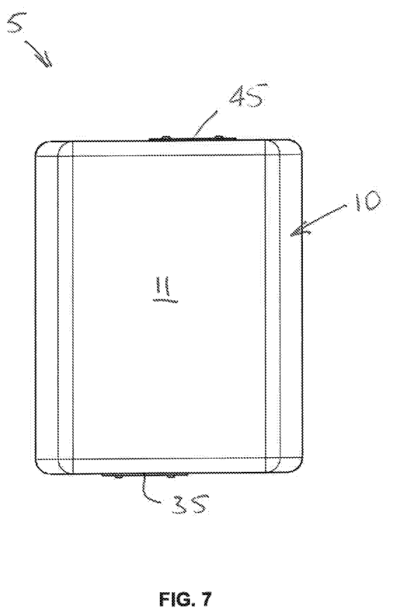

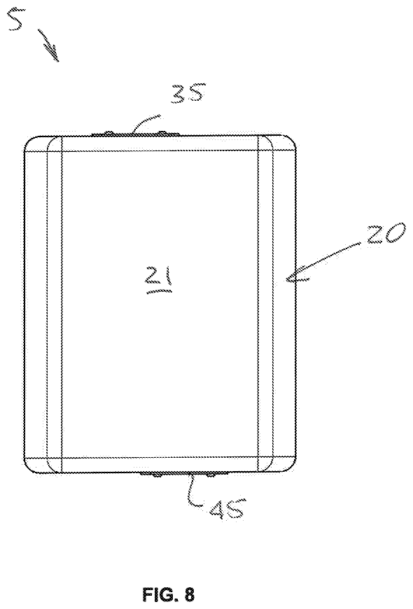

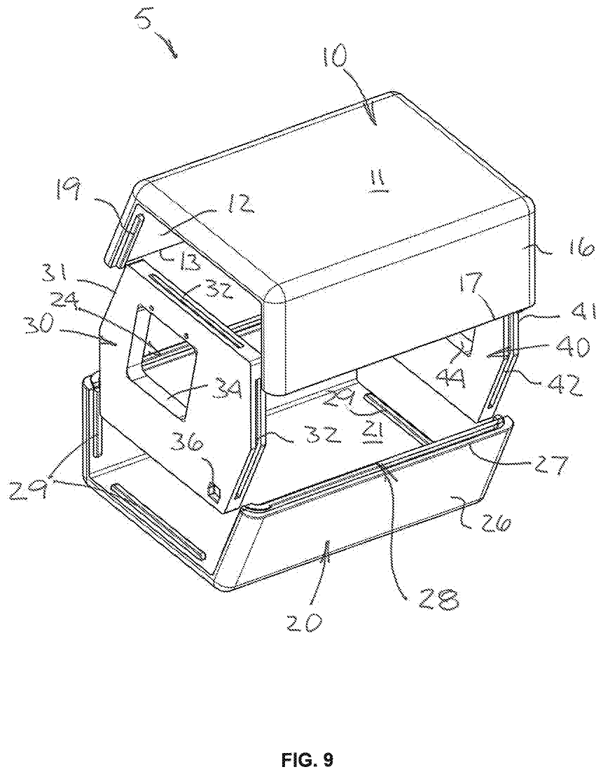

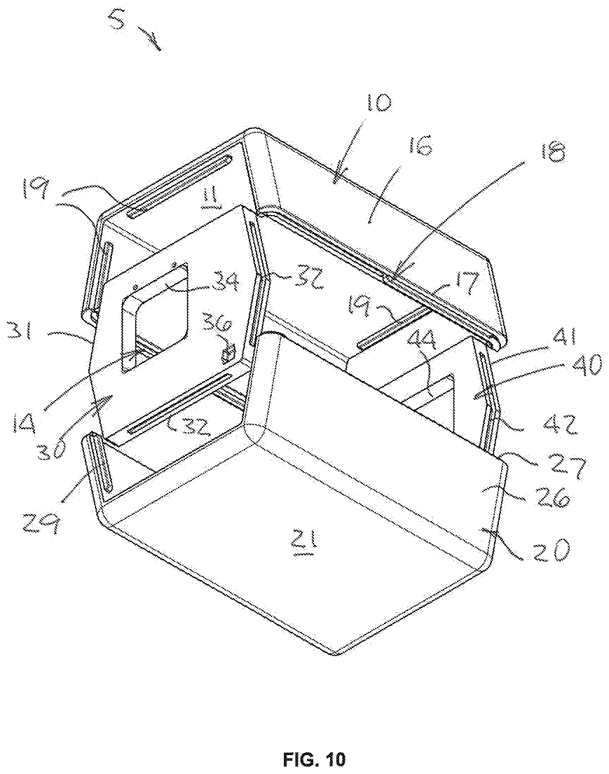

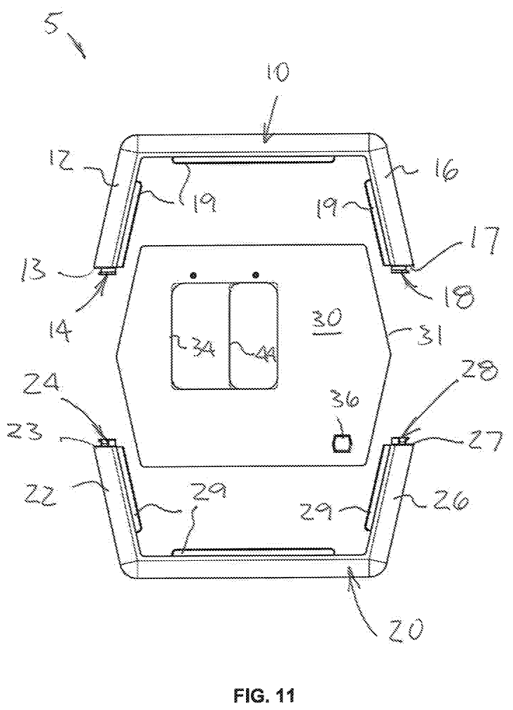

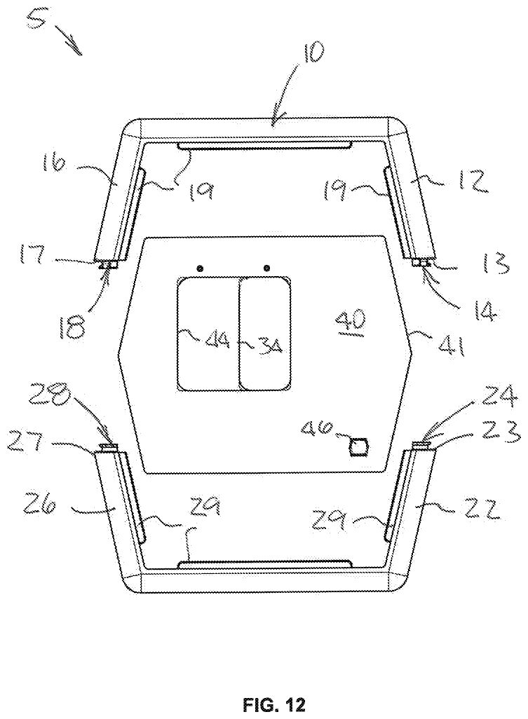

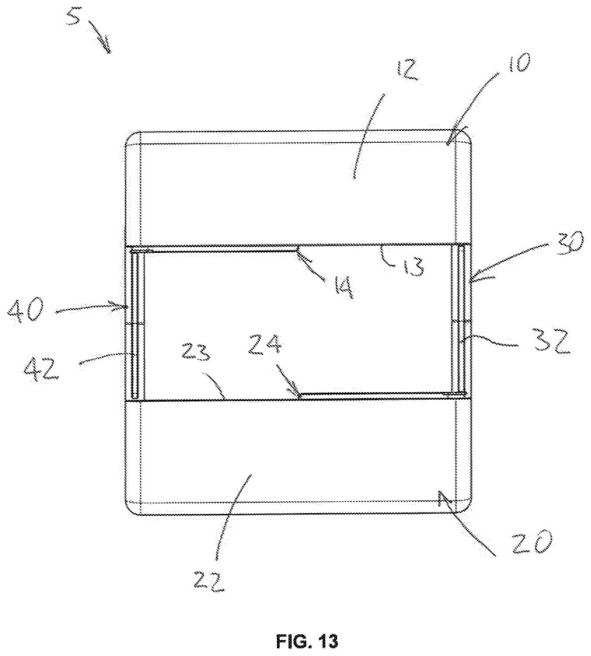

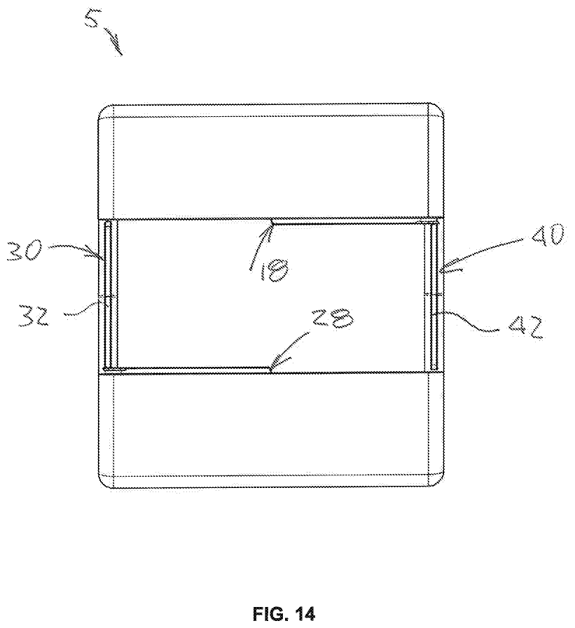

FIGS. 1-14 illustrate a modular animal shelter 5 including a top module 10 and a bottom module 20. The top module 10 includes a top module roof 11, a first top module sidewall 12 and a second top module sidewall 16. The first top module sidewall 12 includes a first lower edge 13 having a first top engagement rib and recess 14 having both a projecting rib and a recessed channel on the first lower edge 13. The second top module sidewall 16 includes a second lower edge 17 having a second top engagement rib and recess 18 having both a projecting rib and a recessed channel on the second lower edge 17. The top module 10 also includes end ribs 19, as more fully described below.

The bottom module 20 includes a bottom module floor 21, a first bottom module sidewall 22 and a second bottom module sidewall 26. The first bottom module sidewall 22 includes a first upper edge 23 having a first bottom engagement rib and recess 24 having both a projecting rib and a recessed channel on the first upper edge 23. The second bottom module sidewall 26 includes a second upper edge 27 having a second bottom engagement rib and recess 28 having both a projection rib and a recessed channel on the second upper edge. The bottom module includes bottom end ribs 29, and more fully described below. When the top module 10 is placed on the bottom module 20, the first and second engagement rib and recesses 14 and 18 of the top module 10 align and engage with the first and second engagement rib and recesses 24 and 28 of the bottom module 20. In the embodiment shown, the sidewalls of the top and bottom modules 10 and 20 are angled to allow stacking during storage and shipment.

In accordance with an embodiment of the invention, the top module 10 and bottom module 20 are of identical shape. As used herein, the term “identical shape” means that two components of the modular animal shelter 5 are substantially the same, e.g., may be manufactured using the same mold.

A first endwall 30 having an outer peripheral edge 31 is installed at one end of the modular animal shelter 5, and a second endwall 40 is installed at an opposite end of the modular animal shelter 5. The first endwall 30 includes a peripheral edge 31 having a first peripheral recess 32. A first door opening 34 with an optional first door flap 35 are provided in the first endwall 30. A first knockout hole 36 is provided in the first endwall 30, e.g., to allow a power cord to pass through the first endwall 30 for purposes of powering an optional heating pad or the like.

The second endwall 40 includes a peripheral edge 41 having second peripheral recesses 42. A second door opening 44 with an optional second door flap 45 are provided in the second endwall 40. A second knockout hole 46 is provided in the endwall 40.

When the first endwall 30 is installed at the first end of the top and bottom modules 10 and 20, the corresponding end ribs 19 of the top module 10 and the corresponding end ribs 29 of the bottom module 20 are received within the first peripheral recess 32 of the first endwall 30. Similarly, when the second endwall 40 is installed at the second end of the top and bottom modules 10 and 20, the corresponding end ribs 19 of the top module 10 and the corresponding end ribs 29 of the bottom module 20 are received within the second peripheral recess 42 of the second endwall 40. As shown, the first and second endwalls 30 and 40 have hexagonal shapes. However, any other suitable shapes may be used.

The first endwall 30 and the second endwall 40 may be of identical shape. As described above, the first module 10 and the second module 20 may be of identical shape. Thus, for manufacturing, only two molds may be needed to form the modular animal shelter 5. A first mold may form the top and bottom modules 10 and 20, and a second mold may form the first and second endwalls 30 and 40, thus resulting in lower cost of manufacture of the components of the modular animal shelter 5.

The first and second endwalls 30 and 40 may be rotatable 180° and reversible. Therefore, each of the modular endwalls may be arranged in one of four orientations. When the first endwall 30 is installed in a first orientation as shown in the figures, the first door opening 34 is oriented toward the top left corner as shown. When the first endwall 30 is rotated 180° to a second orientation, the first door opening 34 is oriented toward the bottom right corner. When the first endwall 30 is reversed into a third position, the first door opening 34 may be in the bottom left corner. When the first endwall 30 is rotated 180° from the third position to a fourth position, the first door opening 34 may be in the top right corner. The second endwall 40 can likewise be oriented into any of the first, second, third, or fourth positions. The orientation of the second endwall 40 may be the same or different from the orientation of the first endwall 30. Any combination of orientations may be used between the first and second endwalls 30 and 40.

The top module 10, bottom module 20, first endwall 30 and second endwall 40 may be made of a thermally insulating material having relatively low thermal conductivity, such as polymeric materials. For example, the thermally insulating material may be closed-cell polymeric foams or expanded polymeric foams, such as expanded polypropylene foam (EPP) or any other suitable material. The wall thickness may be selected based upon the thermal insulation necessary to provide adequate retention of heat to inhabitants of the modular animal shelter 5. The top and bottom modules 10 and 20 may have the same or different thicknesses as the first and second endwalls 30 and 40. The thicknesses may be at least 0.3 inch, for example, at least 0.5 inch, for example, at least 0.75 inch. The thickness may be up to 2 inches or more, for example, up to 1.5 inches. The thicknesses may range from 0.3 or 0.5 inch to 2 inches, for example, from 0.75 inch to 1.5 inches. In a particular example, the thicknesses may be about 1 inch.

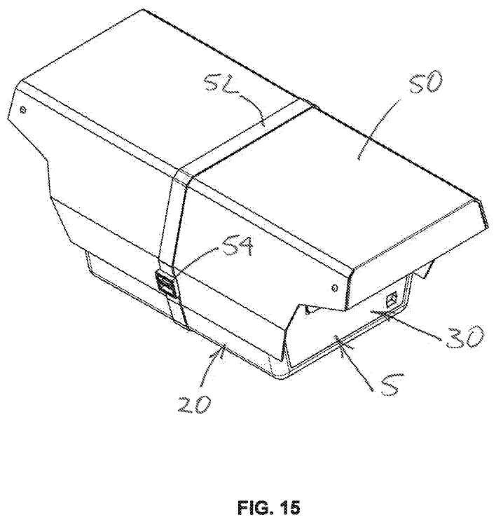

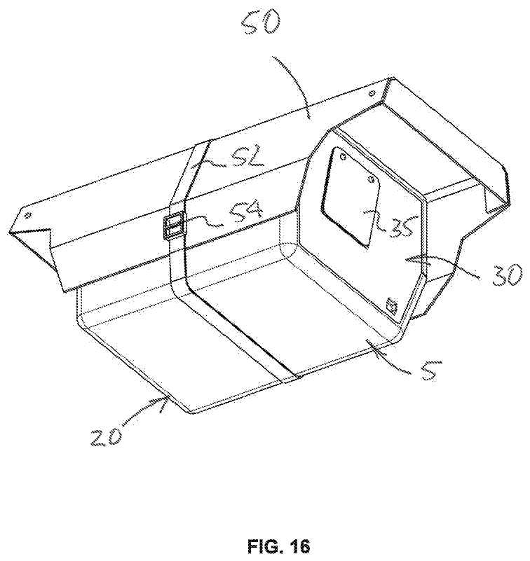

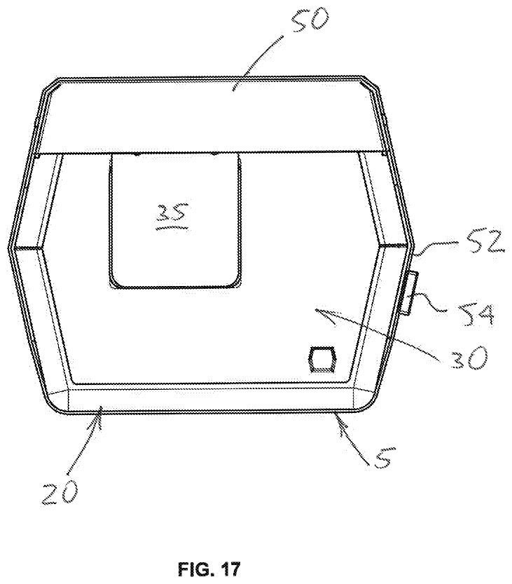

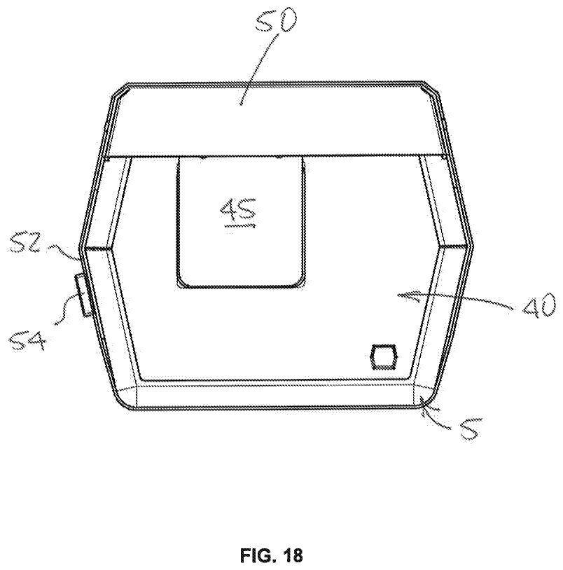

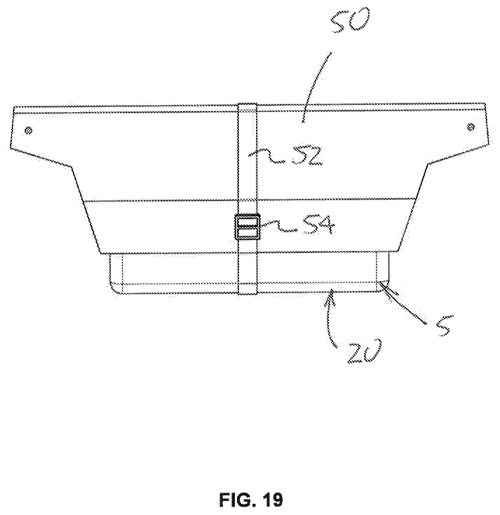

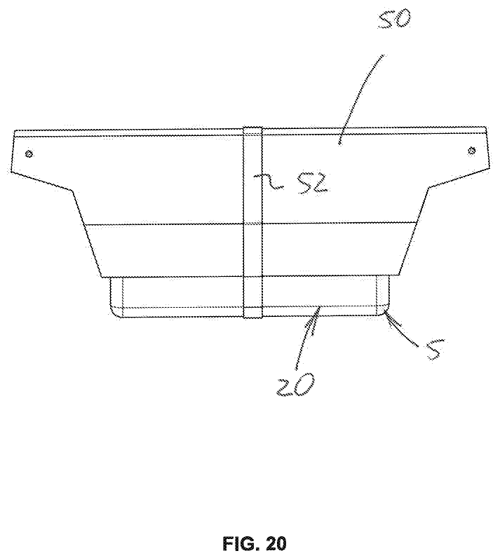

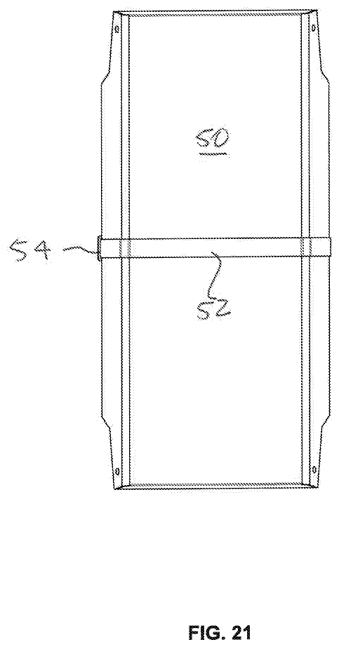

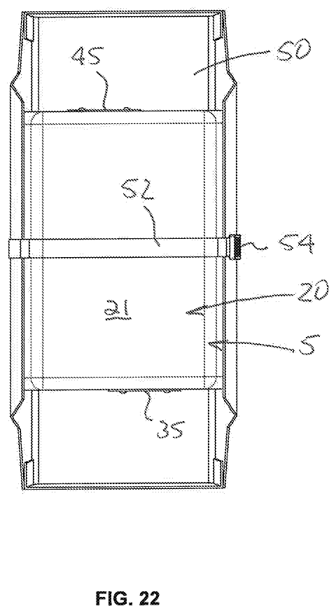

As shown in FIGS. 15-22, the modular animal shelter 5 may include a removable cover 50. A strap 52 and buckle 54 may be used to secure the cover 50 on the modular animal shelter 5. The strap 52 may surround the outside of the modular animal shelter 5.

As used herein, “including,” “containing” and like terms are understood in the context of this application to be synonymous with “comprising” and are therefore open-ended and do not exclude the presence of additional undescribed or unrecited elements, materials, phases or method steps. As used herein, “consisting of” is understood in the context of this application to exclude the presence of any unspecified element, material, phase or method step. As used herein, “consisting essentially of” is understood in the context of this application to include the specified elements, materials, phases, or method steps, where applicable, and to also include any unspecified elements, materials, phases, or method steps that do not materially affect the basic or novel characteristics of the invention.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. In this application and the appended claims, the articles “a,” “an,” and “the” include plural referents unless expressly and unequivocally limited to one referent.

Whereas particular embodiments of this invention have been described above for purposes of illustration, it will be evident to those skilled in the art that numerous variations of the details of the present invention may be made without departing from the invention as defined in the appended claims.

What is claimed is:

1. A modular animal shelter comprising:
a top module including a top module roof, a first top module sidewall having a first lower edge, and a second top module sidewall having a second lower edge; and
a bottom module including a bottom module floor, a first bottom module sidewall having a first upper edge, and a second bottom module sidewall having a second upper edge,
wherein the first lower edge of the first top module sidewall engages the first upper edge of the first bottom module sidewall, and the second lower edge of the second top module sidewall engages the second upper edge of the second bottom module sidewall to thereby form an interior enclosure structured and arranged for an animal to be housed therein, and wherein the top module and bottom module are of identical shape.

2. The modular animal shelter of claim 1, wherein:
the first lower edge of the first top module sidewall comprises a first top module engagement rib and recess, the first upper edge of the first bottom module sidewall comprises a first bottom module engagement rib and recess, and the first top module engagement rib and recess and first bottom module engagement rib and recess engage each other when the top and bottom modules are assembled together; and
the second lower edge of the second top module sidewall comprises a second top module engagement rib and recess, the second upper edge of the second bottom module sidewall comprises a second bottom module engagement rib and recess, and the second top module engagement rib and recess and the second bottom module engagement rib and recess engage each other when the top and bottom modules are assembled together.

3. The modular animal shelter of claim 1, further comprising a first endwall installed at a first end of the modular animal shelter including a peripheral edge adjacent the top module and the bottom module structured and arranged to at least partially enclose the first end of the modular animal shelter.

4. The modular animal shelter of claim 3, further comprising a second endwall installed at a second end of the modular animal shelter opposite the first end including a peripheral edge adjacent the top module and bottom module structured and arranged to at least partially enclose the second end of the modular animal shelter.

5. The modular animal shelter of claim 4, wherein the first endwall and second endwall are of identical shape.

6. The modular animal shelter of claim 4, wherein the first endwall comprises a first door therein, and the second endwall comprises a second door therein.

7. The modular animal shelter of claim 4, wherein each of the first and second endwalls are structured and arranged to be installed in at least two different orientations in relation to the top and bottom modules.

8. The modular animal shelter of claim 7, wherein each of the first and second endwalls are structured and arranged to be installed in four different orientations in relation to the top and bottom modules.

9. The modular animal shelter of claim 4, wherein each of the first and second endwalls include opposing side surfaces and are structured and arranged to be reversibly mounted on the top module and bottom module such that the opposing side surfaces of each endwall may alternatively face the interior enclosure or an exterior of the modular animal shelter.

10. The modular animal shelter of claim 4, wherein:
the peripheral edges of the first and second endwalls comprise peripheral recesses, the top module comprises top end ribs, the bottom module comprises bottom end ribs, and the peripheral recesses of each of the first and second endwalls engage the top end ribs and the bottom end ribs of the top and bottom modules when the first and second endwalls are installed on the top and bottom modules.

11. The modular animal shelter of claim 4, wherein the top module and the bottom module are made of thermally insulating material having a thickness of at least 0.3 inch.

12. The modular animal shelter of claim 11, wherein the first and second endwalls are made of the thermally insulating material.

13. The modular animal shelter of claim 12, wherein the thermally insulating material of the top and bottom modules and the thermally insulating material of the first and second endwalls have thicknesses of from 0.5 to 2 inches.

14. The modular animal shelter of claim 11, wherein the thermally insulating material comprises closed-cell polymeric foam
